(19) United States
(12) Patent Application Publication
(10) Pub. No.: US 2020/0211275 A1
(43) Pub. Date: Jul. 2, 2020

(54) INFORMATION PROCESSING DEVICE, INFORMATION PROCESSING METHOD, AND RECORDING MEDIUM

(71) Applicant: SONY CORPORATION, TOKYO (JP)

(72) Inventors: MASASHI ESHIMA, CHIBA (JP); AKIHIKO KAINO, KANAGAWA (JP); DAIKI YAMANAKA, TOKYO (JP)

(21) Appl. No.: 16/640,493

(22) PCT Filed: Jun. 18, 2018
(86) PCT No.: PCT/JP2018/023124

§ 371 Date: Feb. 20, 2020

(30) Foreign Application Priority Data
Aug. 30, 2017 (JP) 2017-165457

(51) Int. Cl. G06T 17/00; G06T 7/60

(52) U.S. Cl. CPC G06T 17/00; G06T 2219/028; G06T 7/60

(57) ABSTRACT

[Problem] Provided is a technique to reduce volume of data for a model reconstructed from an object in real space and to reconstruct a shape of the object as a further preferable aspect.

[Solution] An information processing device includes: a first estimation unit configured to estimate a first distribution of geometric structure information regarding at least part of a face of an object in real space, in accordance with each of a plurality of beams of polarized light, having different polarization directions from each other, as a result detected by a polarization sensor; a second estimation unit configured to estimate a second distribution of information related to continuity of a geometric structure in the real space based on an estimation result of the first distribution; and a processing unit configured to determine a size of unit data for simulating three-dimensional space in accordance with the second distribution.

### FIELD

The present disclosure relates to an Information processing device, an information processing method, and a recording medium.

### BACKGROUND

In recent years, due to advancement of image identification techniques, it is becoming possible to three-dimensionally estimate (or measure) a position, an orientation, a shape, and the like of an object in real space (hereinafter, will also be referred to as a “real object”) based on an image captured by an imaging unit such as a digital camera. It is also becoming possible to use the position, the orientation, the shape, and the like of the real object estimated to reconstruct (restructure) a three-dimensional shape of the real object as a model, e.g., a polygon model. For example, Non Patent Literature 1 and Non Patent Literature 2 disclose an example of a technique to reconstruct the three-dimensional shape of the real object as a model based on a distance (depth) measured from the real object.

Further, in application of the technique described above, it is becoming possible to estimate (identify) a position and/or an orientation (i.e., a self-position) of a predetermined viewpoint, such as the imaging unit capturing the image of the real object, in the real space.

### CITATION LIST

### Non Patent Literature

Non Patent Literature 1: Matthias Neibner et al., “Real-time 3D Reconstruction at Scale using Voxel Hashing”, ACM Transactions on Graphics (TOG), 2013, [searched on Aug. 11, 2017], Internet <https://graphics.stanford.edu/˜niessner/papers/2013/4hashing/ni essner2013hashing.pdf>

Non Patent Document 2: Frank Stenbrucker et al., “Volumetric 3D Mapping in Real-Time on a CPU”, ICRA, 2014, [searched on Aug. 11, 2017], Internet <http://citeseerx.ist.psu.edu/viewdoc/download?doi=10.1.1.601.15 21&rep=rep1&type=pdf>

### SUMMARY

### Technical Problem

When reconstructing the three-dimensional shape, for example, of the object in the real space as the model above, in other words, when reconstructing three-dimensional space, a wider region targeted for modeling tends to require larger volume of data for the model. Further, when reconstructing the three-dimensional shape of the object at higher accuracy, the volume of the data for the model tends to be even larger.

In view of the respects described above, the present disclosure provides a technique to reduce the volume of the data for the model reconstructed from the object in the real space and to reconstruct the shape of the object as a further preferable aspect.

### Solution to Problem

According to the present disclosure, an information processing device is provided that includes: a first estimation unit configured to estimate a first distribution of geometric structure information regarding at least a part of a face of an object in real space, in accordance with each of a plurality of beams of polarized light, having different polarization directions from each other, as a result detected by a polarization sensor; a second estimation unit configured to estimate a second distribution of information related to continuity of a geometric structure in the real space based on an estimation result of the first distribution; and a processing unit configured to determine a size of unit data for simulating three-dimensional space in accordance with the second distribution.

Moreover, according to the present disclosure, an information processing method performed by a computer, the information processing method is provided that includes: estimating a first distribution of geometric structure information regarding at least a part of a face of an object in real space, in accordance with each of a plurality of beams of polarized light, having different polarization directions from each other, as a result detected by a polarization sensor; estimating a second distribution of information related to continuity of a geometric structure in the real space based on an estimation result of the first distribution; and determining a size of unit data for simulating three-dimensional space in accordance with the second distribution.

Moreover, according to the present disclosure, a recording medium is provided that is recorded a program for causing a computer to execute: estimating a first distribution of geometric structure information regarding at least a part of a face of an object in real space, in accordance with each of a plurality of beams of polarized light, having different polarization directions from each other, as a result detected by a polarization sensor; estimating a second distribution of information related to continuity of a geometric structure in the real space based on an estimation result of the first distribution; and determining a size of unit data for simulating three-dimensional space in accordance with the second distribution.

### Advantageous Effects of Invention

As has been described above, the present disclosure provides a technique to reduce volume of data for a model reconstructed from an object in real space and to reconstruct a shape of the object as a further preferable aspect.

Note that the effects described above are not necessarily limitative. In addition to or in place of the effects described above, any one of effects described in this specification or other effects grasped from this specification may be encompassed within the present disclosure.

### BRIEF DESCRIPTION OF DRAWINGS

FIG. 1 is an explanatory diagram illustrating a schematic configuration example of an information processing system according to an embodiment of the present disclosure.

FIG. 2 is an explanatory diagram illustrating a schematic configuration example of an input/output device according to the embodiment.

FIG. 3 is a block diagram illustrating a functional configuration example of the information processing system according to the embodiment.

FIG. 4 is an explanatory diagram illustrating an exemplary flow of a process performed in a geometric continuity estimation unit.

FIG. 5 is an explanatory diagram illustrating an overview of a geometric continuity map.

FIG. 6 is an explanatory diagram, each illustrating an overview of the geometric continuity map.

FIG. 7 is an explanatory diagram illustrating an exemplary flow of a process performed in an integrated processing unit.

FIG. 8 is an explanatory diagram illustrating an exemplary flow of a process to merge voxels into one and/or split the voxel.

FIG. 9 is an explanatory diagram illustrating an exemplary result of controlling a size of the voxel.

FIG. 10 is a flowchart illustrating an exemplary flow of a series of process steps performed in the information processing system according to the embodiment.

FIG. 11 is a functional block diagram illustrating a configuration example of a hardware configuration in an information processing device included in an information processing system according to an embodiment of the present disclosure.

### DESCRIPTION OF EMBODIMENTS

Hereinafter, a preferred embodiment of the present disclosure will be described in detail with reference to the accompanying drawings. Note that, in this specification and the accompanying drawings, structural elements that have substantially identical functions and structures are denoted with the same reference signs, and repeated explanation of these structural elements is thus omitted.

Note that the description will be provided in the following order.

1. Schematic configuration

1.1. System configuration

1.2. Configuration of input/output device

2. Study of 3D modeling

3. Technical feature

3.1. Functional configuration

3.2. Process

4. Hardware configuration

5. Conclusion

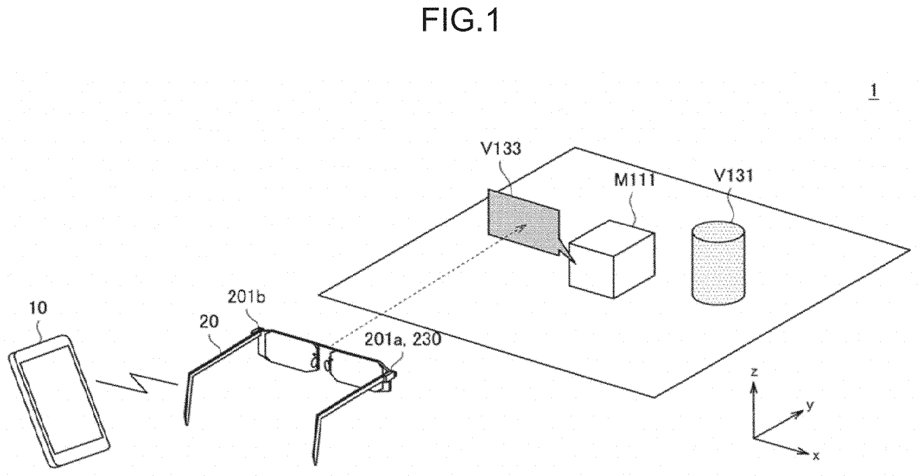

«1. Schematic Configuration»

<1.1. System Configuration>First, a schematic configuration example of an information processing system according to an embodiment of the present disclosure will be described with reference to FIG. 1. FIG. 1 is an explanatory diagram illustrating the schematic configuration example of the information processing system according to the embodiment of the present disclosure, and illustrates an example of displaying to a user various contents based on a typically-called augmented reality (AR) technique.

In FIG. 1, an object positioned in real space (e.g., a real object) is schematically illustrated with reference sign m111. Additionally, virtual contents (e.g., virtual objects), each displayed to be superimposed in the real space, are schematically illustrated with reference signs v131 and v133. In other words, an information processing system 1 according to this embodiment displays to the user the object in the real space, such as the real object m111, with the virtual object superimposed on the object in the real space by using, for example, the AR technique. Note that FIG. 1 illustrates both the real object and the virtual objects such that the feature of the information processing system according to this embodiment is more easily identified.

As illustrated in FIG. 1, the information processing system 1 according to this embodiment includes an information processing device 10 and an input/output device 20. The information processing device 10 and the input/output device 20 are configured to transmit/receive information to/from each other via a predetermined network. The type of the network connecting the information processing device 10 with the input/output device 20 is not particularly limited. As a specific example, the network may be a typical wireless network such as a Wi-Fi (registered trademark) standard network. Alternatively, as another example, the network may be an internet, a leased line, a local area network (LAN), a wide area network (WAN), or the like. Still alternatively, the network may include a plurality of networks or may be at least partially wired.

The input/output device 20 is configured to acquire various input information and to display various output information for the user holding the input/output device 20. The information processing device 10 is configured to control the input/output device 20 to display the output information based on the input information acquired by the input/output device 20. For example, the input/output device 20 acquires information to identify the real object m111 (e.g., an image of the real space captured) as the input information, and outputs the information acquired to the information processing device 10. The information processing device 10 identifies a position and/or an orientation of the real object m111 in the real space based on the information acquired from the input/output device 20. Then, based on a result of the identification, the information processing device 10 causes the input/output device 20 to display the virtual object v131 and the virtual object v133. Under this control, the input/output device 20 displays to the user the virtual objects v131 and v133 based on the AR technique, in a way that the virtual objects v131 and v133 are superimposed on the real object m111.

The input/output device 20 is, for example, a typically-called head mounted device that is worn on at least part of a head of the user, and may be configured to detect a viewpoint of the user. With such a configuration, the information processing device 10 identifies, for example, a desired target at which the user gazes (e.g., the real object m111, the virtual object v131, the virtual object v133, or the like) based on the viewpoint of the user detected by the input/output device 20. In this case, the information processing device 10 may specify the desired target as an operational target. Alternatively, the information processing device 10 may regard a predetermined operation of the input/output device 20 input by the user as a trigger to identify a target to which the viewpoint of the user is directed, and specify the target as the operational target. Accordingly, the information processing device 10 may specify the operational target and execute a process related to the operational target, so as to provide various services to the user via the input/output device 20.

As has been described, the information processing system according to this embodiment identifies the object in the real space (real object), and here, a more specific configuration example of the information processing system will be described. As illustrated in FIG. 1, the input/output device 20 according to this embodiment includes a depth sensor 201 and a polarization sensor 230.

The depth sensor 201 acquires information to estimate a distance between a predetermined viewpoint and the object positioned in the real space (the real object), and transmits the information acquired to an information processing device 100. Hereinafter, the information that the depth sensor 201 acquires to estimate the distance between the predetermined viewpoint and the real object will also be referred to as “depth information”.

In the example illustrated in FIG. 1, the depth sensor 201 is a typical stereo camera that includes a plurality of imaging units, i.e., an imaging unit 201a and an imaging unit 201b. The imaging units 201a and 201b capture images of the object positioned in the real space from respective viewpoints that are different from each other. In this case, the depth sensor 201 transmits the image captured by each of the imaging units 201a and 201b to the information processing device 100.

With this configuration, a plurality of images are captured from the different viewpoints, and based on, for example, parallax between the plurality of images, it is possible to estimate (calculate) the distance between the predetermined viewpoint (e.g., a position of the depth sensor 201) and a subject (i.e., the real object captured in each of the images). Thus, it is also possible, for example, to generate a typically-called depth map where the distance estimated between the predetermined viewpoint and the subject is mapped out on an imaging plane.

Note that, when it is possible to estimate the distance between the predetermined viewpoint and the object in the real space (real object), a configuration of a part corresponding to the depth sensor 201 or a method to estimate the distance is not particularly limited. As a specific example, the distance between the predetermined viewpoint and the real object may be measured based on a method such as a multi-camera stereo, moving parallax, a time of flight (TOF), or a structured light system. Here, the TOF is a measurement of time taken by light, e.g., infrared light, radiated to the subject (i.e., the real object) to return after reflecting from the subject, and the time is measured for each pixel. Based on a result of the measurement, the image including the distance to the subject (depth), in other words, the depth map is obtained. The structured light system is to radiate the subject with a pattern of light, e.g., the infrared light, to capture the image. Then, based on a change in the pattern obtained from the image captured, the depth map including the distance to the subject (depth) is obtained. The moving parallax is a method of measuring the distance to the subject based on the parallax, even in a case of a monocular camera. Specifically, the monocular camera moves to capture the images of the subject from different viewpoints, and based on the parallax between the images captured, the distance to the subject is measured. Note that, with various sensors that identify a distance and a direction of the moving camera, it is possible to more accurately measure the distance to the subject. The configuration of the depth sensor 201 (e.g., the monocular camera, the stereo camera, or the like) may be changed in accordance with the method of measuring the distance.

The polarization sensor 230 detects light polarized in a predetermined polarization direction (hereinafter, will be simply referred to as “polarized light”) out of light reflecting from the object positioned in the real space, and transmits information corresponding to a result of detecting the polarized light to the information processing device 100. In the information processing system 1 according to this embodiment, the polarization sensor 230 is configured to detect a plurality of beams of polarized light (more preferably, three or more beams of polarized light), each having a different polarization direction from the others. Hereinafter, the information corresponding to the polarized light detected by the polarization sensor 230 will also be referred to as “polarization information”.

As a specific example, the polarization sensor 230 is a typically-called polarization camera, and captures a polarization image based on the light polarized in the predetermined polarization direction. Here, the polarization image corresponds to the information in which the polarization information is mapped out on the imaging plane (in other words, an image plane) of the polarization camera. In this case, the polarization sensor 230 transmits the polarization image captured to the information processing device 100.

Additionally, the polarization sensor 230 may preferably be configured to capture the polarized light coming from a region that is at least partially superimposed on (ideally, a region substantially matching) a region in the real space, i.e., the region in the real space from which the depth sensor 201 acquires the information to estimate the distance. Note that, when each of the depth sensor 201 and the polarization sensor 230 is fixed at a predetermined position, information indicating the position of each of the depth sensor 201 and the polarization sensor 230 in the real space may be previously obtained to be used as known information.

Further, as illustrated in FIG. 1, the depth sensor 201 and the polarization sensor 230 are preferably held in a shared device (e.g., the input/output device 20). In this case, a relative positional relationship that each of the depth sensor 201 and the polarization sensor 230 has with respect to the shared device may be previously calculated. Thus, based on a position and an orientation of the shared device, it is possible, for example, to estimate a position and an orientation of each of the depth sensor 201 and the polarization sensor 230.

Further, the shared device, in which the depth sensor 201 and the polarization sensor 230 are held (e.g., the input/output device 20) may be configured to be movable. In this case, a technique called self-position estimation may be applied to estimate the position and the orientation of the shared device in the real space.

Next, as a more specific example of the technique to estimate a position and an orientation of a predetermined device in the real space, a technique called simultaneous localization and mapping (SLAM) will be described. The SLAM uses various sensors, an encoder, an imaging unit such as a camera, or the like to concurrently perform the self-position estimation and construct a map of an environment. As a more specific example, based on a moving image captured by the imaging unit, the SLAM (particularly visual SLAM) sequentially restores a three-dimensional shape of a scene (or the subject) captured. Then, the SLAM correlates a restored result of the scene captured with a position and an orientation of the imaging unit detected, so as to construct the map of the environment surrounding the imaging unit and estimate the position and the orientation of the imaging unit in the environment. Note that with various sensors, such as an acceleration sensor or an angular velocity sensor, provided to a device in which the imaging unit is held, it is possible to estimate the position and the orientation of the imaging unit based on results detected by the various sensors (as relative change information). It is naturally to be understood that, when it is possible to estimate the position and the orientation of the imaging unit, the estimation method is not necessarily limited to the method based on the results detected by the various sensors, such as the acceleration sensor or the angular velocity sensor.

Further, at least one of the depth sensor 201 and the polarization sensor 230 may be configured to be movable separately from the other. In this case, the depth sensor 201 configured to be movable or the polarization sensor 230 configured to be movable preferably has its own position and its own orientation in the real space estimated separately, based on, for example, the self-position estimation technique described above, or other techniques.

The information processing device 100 acquires the depth information and the polarization information from the depth sensor 201 and the polarization sensor 230, but may instead acquire the information above from the input/output device 20. In this case, for example, the information processing device 100 may identify the real object positioned in the real space based on the depth information and the polarization information acquired, so as to generate a model in which the three-dimensional shape of the real object is reconstructed. Further, based on the depth information and the polarization information acquired, the information processing device 100 may correct the model generated. A process to generate the model and a process to correct the model will be separately described in detail later.

Note that the configurations described above are merely illustrative, and thus the system configuration of the information processing system 1 according to this embodiment is not necessarily limited to the example illustrated in FIG. 1. As a specific example, the input/output device 20 and the information processing device 10 may be integrally formed. A configuration and a process of each of the input/output device 20 and the information processing device 10 will be separately described in detail later.

The schematic configuration example of the information processing system according to the embodiment of the present disclosure has been described above with reference to FIG. 1.

<1.2. Configuration of Input/Output Device>

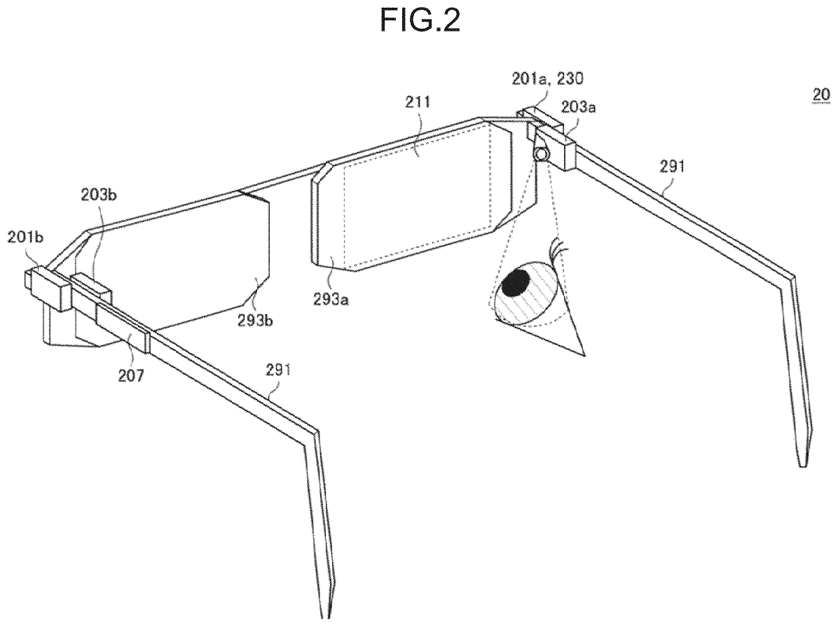

Next, a schematic configuration example of the input/output device 20 according to this embodiment as illustrated in FIG. 1 will be described with reference to FIG. 2. FIG. 2 is an explanatory diagram illustrating the schematic configuration example of the input/output device according to this embodiment.

As has been described, the input/output device 20 according to this embodiment is the typically-called head mounted device that is worn on at least part of the head of the user. For example, in the example illustrated in FIG. 2, the input/output device 20 is a typically-called eyewear (eyeglasses) device, and at least one of a lens 293a and a lens 293b is a transmission-type display (a display unit 211). The input/output device 20 includes the imaging unit 201a, the imaging unit 201b, the polarization sensor 230, an operation unit 207, and a holding unit 291, each corresponding to a part of a frame of the eyeglasses. Further, the input/output device 20 may include an imaging unit 203a and an imaging unit 203b. Note that, hereinafter, various descriptions will be provided on an assumption that the input/output device 20 includes the imaging units 203a and 203b. When the input/output device 20 is worn on the head of the user, the holding unit 291 holds each of the display unit 211, the imaging unit 201a, the imaging unit 201b, the polarization sensor 230, the imaging unit 203a, the imaging unit 203b, and the operation unit 207 in a predetermined position with respect to the head of the user. Note that the imaging unit 201a, the imaging unit 201b, and the polarization sensor 230 respectively correspond to the imaging unit 201a, the imaging unit 201b, and the polarization sensor 230 illustrated in FIG. 1. While not illustrated in FIG. 2, the input/output device 20 may also include a sound collecting unit for collecting a voice of the user.

Here, a more specific configuration of the input/output device 20 will be described. For example, in the example illustrated in FIG. 2, the lens 293a corresponds to a right-eye lens, and the lens 293b corresponds to a left-eye lens. In other words, when the input/output device 20 is worn, the holding unit 291 holds the display unit 211 (i.e., the lenses 293a and 293b) in a way that the display unit 211 is positioned in front of eyes of the user.

Each of the imaging units 201a and 201b is the typical stereo camera, and is held by the holding unit 291 to face in a direction in which the head of the user faces (i.e., frontward of the user) when the input/output device 20 is worn on the head of the user. In this state, the imaging unit 201a is held in a vicinity of a right eye of the user, and the imaging unit 201b is held in a vicinity of a left eye of the user. With such a configuration, the imaging units 201a and 201b capture the images of the subject positioned frontward of the input/output device 20 (i.e., the real object positioned in the real space) from respective positions that are different from each other. Accordingly, the input/output device 20 acquires the images of the subject positioned frontward of the user; and concurrently, based on the parallax between the images captured by the imaging units 201a and 201b, it is possible to calculate the distance from the input/output device 20 (in addition to the viewpoint of the user) to the subject.

As has been described, when it is possible to measure the distance between the input/output device 20 and the subject, the configuration or the method to measure the distance is not particularly limited.

Each of the imaging units 203a and 203b is also held by the holding unit 291 to have an eyeball of the user positioned within the corresponding imaging range when the input/output device 20 is worn on the head of the user. As a specific example, the imaging unit 203a is held to have the right eye of the user positioned in the imaging range. With such a configuration, based on an image on a right eyeball captured by the imaging unit 203a and a positional relationship between the right eye and the imaging unit 203a, it is possible to identify a direction in which a viewpoint from the right eye faces. Similarly, the imaging unit 203b is held to have the left eye of the user positioned within the imaging range. In other words, based on an image on a left eyeball captured by the imaging unit 203b and a positional relationship between the left eye and the imaging unit 203b, it is possible to identify a direction in which a viewpoint from the left eye faces. In the example illustrated in FIG. 2, the input/output device 20 is configured to include both the imaging units 203a and 203b, but alternatively may include only one of the imaging units 203a and 203b.

The polarization sensor 230 here corresponds to the polarization sensor 230 illustrated in FIG. 1, and is held by the holding unit 291 to face in the direction in which the head of the user faces (i.e., frontward of the user) when the input/output device 20 is worn on the head of the user. With such a configuration, the polarization sensor 230 captures the polarization image in space in front of the eyes of the user wearing the input/output device 20. Note that the position of the polarization sensor 230 illustrated in FIG. 2 is merely illustrative; and when the polarization sensor 230 is capable of capturing the polarization image in the space in front of the eyes of the user wearing the input/output device 20, the position of the polarization sensor 230 is not limited.

The operation unit 207 is configured to receive the operation of the input/output device 20 input by the user. The operation unit 207 may be an input device such as a touch panel or a button. The operation unit 207 is held by the holding unit 291 at a predetermined position in the input/output device 20. For example, in the example illustrated in FIG. 2, the operation unit 207 is held at a position corresponding to a temple of the eyeglasses.

The input/output device 20 according to this embodiment may be provided with, for example, the acceleration sensor or the angular velocity sensor (a gyro sensor) to detect a movement of the head of the user wearing the input/output device 20 (in other words, an own movement of the input/output device 20). As a specific example of detecting the movement of the head of the user, the input/output device 20 may detect each component in a yaw direction, in a pitch direction, and in a roll direction, so as to identify a change in at least one of a position and an orientation of the head of the user.

The configuration described above causes the input/output device 20 according to this embodiment to identify a change in its own position and/or orientation in accordance with the movement of the head of the user. The configuration also causes the input/output device 20 to display the virtual content (i.e., the virtual object) on the display unit 211 based on the AR technique in the way that the virtual content is superimposed on the real object positioned in the real space. In this state, the input/output device 20 may estimate its own position and orientation in the real space (i.e., the self-position) based on, for example, the technique called SLAM or the like that has been described above, and use a result of the estimation to display the virtual object.

An example of a head mounted display (HMD) device applicable as the input/output device 20 includes a see-through HMD, a video see-through HMD, and a retinal projection HMD.

The see-through HMD uses, for example, a half mirror or a transparent light guide plate in order to hold a virtual image optical system formed of a transparent light guide unit or the like in front of the eyes of the user and display an image inside the virtual image optical system. Thus, when wearing the see-through HMD, the user views the image displayed inside the virtual image optical system, while including an external landscape within a field of view of the user. With such a configuration, the see-through HMD may use, for example, the AR technique to display an image of the virtual object to be superimposed on an optical image of the real object positioned in the real space, in accordance with at least one of a position and an orientation of the see-through HMD that has been identified. A specific example of the see-through HMD includes a typically-called eyeglasses wearable device in which a part corresponding to each of lenses of the eyeglasses is configured as the virtual image optical system. For example, the input/output device 20 illustrated in FIG. 2 corresponds to the example of the see-through HMD.

When the video see-through HMD is worn on the head or a face of the user, the video see-through HMD is worn to cover the eyes of the user such that its display unit such as a display is held in front of the eyes of the user. The video see-through HMD includes an imaging unit configured to capture an image of its surrounding landscape, and displays, on the display unit, the image of the landscape positioned frontward of the user and captured by the imaging unit. With such a configuration, the user wearing the video see-through HMD, while having a difficulty with directly including the external landscape within the field of his/her view, confirms the external landscape based on the image displayed on the display unit. In this state, the video see-through HMD may use, for example, the AR technique to display the virtual object to be superimposed on the image of the external landscape, in accordance with at least one of a position and an orientation of the video see-through HMD that has been identified.

The retinal projection HMD holds a projection unit in front of the eyes of the user, and the project unit projects an image on each of the eyes of the user in a way that the image is superimposed on the external landscape. More specifically, in the retinal projection HMD, the projection unit projects the image directly on a retina of each of the eyes of the user such that the image is formed on the retina. Such a configuration causes the user to view a clearer image even when the user is short sighted or far sighted. Additionally, the user wearing the retinal projection HMD views the image projected from the projection unit, while including the external landscape within the field of his/her view. With such a configuration, the retinal projection HMD uses, for example, the AR technique to display the image of the virtual object to be superimposed on the optical image of the real object positioned in the real space, in accordance with at least one of a position and an orientation of the retinal projection HMD that has been identified.

The configuration example of the input/output device 20 according to this embodiment has been described above on an assumption that the AR technique is applied, but the configuration of the input/output device 20 is not limited thereto. For example, on an assumption that a VR technique is applied, the input/output device 20 according to this embodiment may employ an HMD called an immersive HMD. As with the video see-through HMD, the immersive HMD is worn to cover the eyes of the user such that its display unit such as a display is held in front of the eyes of the user. Thus, the user wearing the immersive HMD has the difficulty with directly including the external landscape (i.e., a real-world landscape) within the field of his/her view, and thus only views an image displayed on the display unit. With such a configuration, the immersive HMD provides a sense of immersion to the user viewing the image.

Note that the configuration of the input/output device 20 described above is merely illustrative and thus not necessarily limited to the configuration illustrated in FIG. 2. As a specific example, in accordance with a use or a function of the input/output device 20, an additional configuration may be employed for the input/output device 20. As a specific example for the additional configuration, the input/output device 20 may include, as an output unit configured to present information to the user, a sound output unit (e.g., a speaker or the like) for presenting voice or sound, an actuator for providing tactile or force feedback, or others.

The schematic configuration example of the input/output device according to the embodiment of the present disclosure has been described above with reference to FIG. 2.

«2. Study of 3D Modeling»

Next, an overview of techniques for 3D modeling to reconstruct three-dimensional space, such as a case of reconstructing a three-dimensional shape or the like of an object in the real space (real object) as a model, e.g., a polygon model, will be described. Then, a technical object of the information processing system according to this embodiment will be summarized.

The 3D modeling uses, for example, an algorithm configured to hold information indicating a position of the object in the three-dimensional space; hold data (hereinafter, will also be referred to as “3D data”), such as data for a distance from a surface of the object or a weight based on the number of observations; and update the data based on information from a plurality of viewpoints (e.g., a depth or the like). The techniques for the 3D modeling include, as an example, a generally known technique for using the distance (depth) from the object in the real space detected by a depth sensor or the like.

On the other hand, when using the depth sensor represented by a TOF sensor or the like, resolution tends to be low, and further, an increase in the distance from the object to be detected as the depth tends to degrade an accuracy of the detection and increase an influence of noise. With such characteristics, when performing the 3D modeling based on the depth detected, there is a difficulty in acquiring information related to a geometric structure (in other words, a geometric feature) of the object in the real space (hereinafter, the information will also be referred to as “geometric structure information”) precisely and highly accurately with a relatively small number of observations.

In view of the circumstances, the information processing system according to this embodiment, as previously described, includes a polarization sensor configured to detect polarized light reflecting from the object positioned in the real space, and uses polarization information corresponding to the polarized light detected for the 3D modeling. Generally, when acquiring the geometric structure information based on a polarization image captured by the polarization sensor, the resolution tends to be higher compared with based on the depth information acquired by the depth sensor, and even with the increase in the distance from the object to be detected, the accuracy of the detection is less prone to be degraded. In other words, when performing the 3D modeling based on the polarization information, it is possible to acquire the geometric structure information of the object in the real space precisely and highly accurately with the relatively small number of observations. The 3D modeling using the polarization information will be separately described in detail later.

When reconstructing the three-dimensional space as the polygon model or the like, a wider region targeted for the 3D modeling tends to require larger volume of the 3D data (in other words, volume of data for the model). Such a problem may also arise in the case of the 3D modeling using the polarization information.

In view of these circumstances, the present disclosure provides a technique to reduce the volume of the data for the model reconstructed from the object in the real space and to reconstruct the shape of the object as a further preferable aspect. Specifically, in general techniques for the 3D modeling, the 3D data is evenly located on the surface of the object, and based on the 3D data, a polygon mesh or the like is generated. However, compared with a case of reconstructing a complex shape such as an edge, a simple shape such as a plane may be reconstructed based on less dense 3D data. Accordingly, based on the 3D modeling using the polarization information together with the characteristics described above, the information processing system according to the present disclosure reduces the volume of the data for the model while maintaining reconstruction of the three-dimensional space. Hereinafter, technical features of the information processing system according to this embodiment will be described in further detail.

«3. Technical Features»

The technical features of the information processing system according to this embodiment will be described below.

<3.1. Functional Configuration>

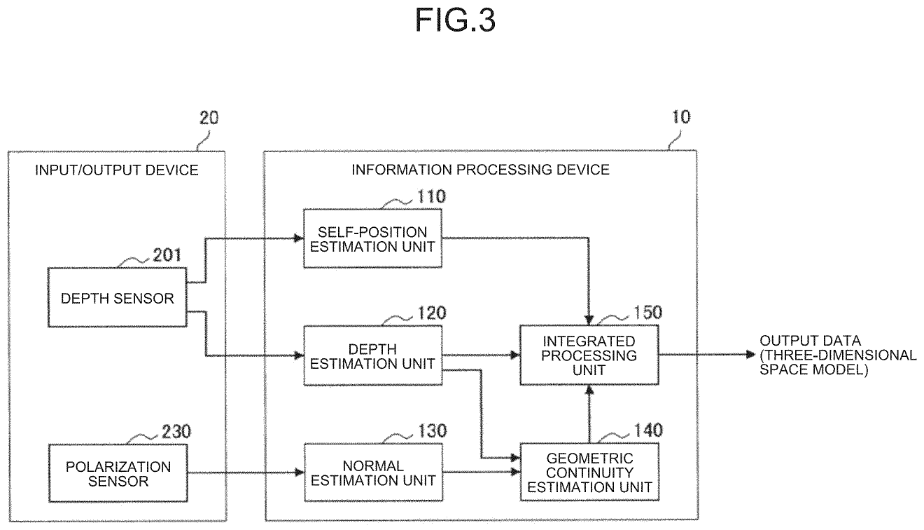

First, a functional configuration example of the information processing system according to this embodiment will be described with reference to FIG. 3. FIG. 3 is a block diagram illustrating the functional configuration example of the information processing system according to this embodiment. Note that, in the example illustrated in FIG. 3, as with the example described with reference to FIG. 1, the description will be provided on an assumption that the information processing system 1 includes the input/output device 20 and the information processing device 10. In other words, the input/output device 20 and the information processing device 10 illustrated in FIG. 3 respectively correspond to the input/output device 20 and the information processing device 10 illustrated in FIG. 1. Additionally, the input/output device 20 will be described on an assumption that the input/output device 20 described with reference to FIG. 2 is employed.

As illustrated in FIG. 3, the input/output device 20 includes the depth sensor 201 and the polarization sensor 230. The depth sensor 201 here corresponds to the depth sensor 201 illustrated in FIG. 1 and the imaging units 201a and 201b illustrated in FIG. 2. The polarization sensor 230 here corresponds to the polarization sensor 230 illustrated in each of FIGS. 1 and 2. Each of the depth sensor 201 and the polarization sensor 230 has been described, and thus a detailed description thereof will be omitted.

Next, a configuration of the information processing device 10 will be described. As illustrated in FIG. 3, the information processing device 10 includes a self-position estimation unit 110, a depth estimation unit 120, a normal estimation unit 130, a geometric continuity estimation unit 140, and an integrated processing unit 150.

The self-position estimation unit 110 estimates the position of the input/output device 20 (particularly, the polarization sensor 230) in the real space. In this state, the self-position estimation unit 110 estimates the orientation of the input/output device 20 in the real space. Hereinafter, the position and the orientation of the input/output device 20 in the real space will collectively be referred to as the “self-position of the input/output device 20”. In other words, in the following description, the “self-position of the input/output device 20” includes at least one of the position and the orientation of the input/output device 20 in the real space.

Note that, when the self-position estimation unit 110 is capable of estimating the self-position of the input/output device 20, a technique related to the estimation or a configuration and information used for the estimation is not particularly limited. As a specific example, the self-position estimation unit 110 may estimate the self-position of the input/output device 20 based on the technique called SLAM that has been previously described. In this case, for example, the self-position estimation unit 110 may estimate the self-position of the input/output device 20 based on the depth information acquired by the depth sensor 201 and the change in position and/or orientation of the input/output device 20 detected by a predetermined sensor (e.g., the acceleration sensor, the angular velocity sensor, or the like).

Further, the self-position estimation unit 110 may previously calculate the relative positional relationship of the polarization sensor 230 to the input/output device 20, so as to calculate a self-position of the polarization sensor 230 based on the self-position of the input/output device 20 estimated.

Then, the self-position estimation unit 110 outputs information to the integrated processing unit 150, the information corresponding to the self-position of the input/output device 20 (in addition to the self-position of the polarization sensor 230) estimated.

The depth estimation unit 120 acquires the depth information from the depth sensor 201, and estimates the distance between the predetermined viewpoint (e.g., the depth sensor 201) and the object positioned in the real space based on the depth information acquired. Note that in the following description, the depth estimation unit 120 estimates the distance between the input/output device 20 in which the depth sensor 201 is held (strictly, a predetermined position as a datum of the input/output device 20) and the object positioned in the real space.

As a specific example, when the depth sensor 201 is the stereo camera, the depth estimation unit 120 estimates the distance between the input/output device 20 and the subject based on the parallax between the images of the subject captured by the plurality of the imaging units included in the stereo camera (e.g., the imaging units 201a and 201b illustrated in FIGS. 1 and 2). In this state, the depth estimation unit 120 may generate the depth map where the distance estimated is mapped out on the imaging plane. Then, the depth estimation unit 120 outputs, to the geometric continuity estimation unit 140 and the integrated processing unit 150, information (e.g., the depth map) corresponding to the distance estimated between the input/output device 20 and the object positioned in the real space.

A normal estimation unit 109 acquires a polarization image from the polarization sensor 230. Based on polarization information included in the polarization image acquired, the normal estimation unit 109 estimates information related to the geometric structure (e.g., a normal) of at least part of a face (e.g., the surface) of the object in the real space captured in the polarization image, that is, the geometric structure information.

The geometric structure information includes, for example, information corresponding to an amplitude and a phase obtained by fitting a cosine curve to a polarization value of each polarized light detected, or information related to the normal of the face of the object calculated based on the amplitude and the phase obtained (hereinafter, the information will also be referred to as “normal information”). The normal information includes information as a normal vector indicated as a zenith angle and an azimuth angle, information as the normal vector indicated in a three-dimensional coordinate system, or the like. The zenith angle may be calculated based on the amplitude of the cosine curve. The azimuth angle may be calculated based on the phase of the cosine curve. It is naturally to be understood that the zenith angle and the azimuth angle may be converted to the three-dimensional coordinate system, such as an X-Y-Z coordinate system. Here, information regarding a distribution of the normal information, i.e., the normal information mapped out on the image plane of the polarization image, corresponds to a typically-called normal map. Further, information related to the polarized light before being subjected to the imaging process above, i.e., the polarization information, may be used as the geometric structure information. Note that a distribution of the geometric structure information (for example, the normal information) such as a normal map corresponds to an example of a “first distribution”.

In the following description, the normal estimation unit 109 estimates the normal information regarding at least part of the face (e.g., the surface) of the object, in other words, a polarization normal of the object, as the geometric structure information. In this state, the normal estimation unit 109 may generate the normal map where the normal information estimated is mapped out on the imaging plane. Then, the normal estimation unit 109 outputs information corresponding to the normal information estimated (e.g., the normal map) to the geometric continuity estimation unit 140. Note that the normal estimation unit 109 corresponds to an example of a “first estimation unit”.

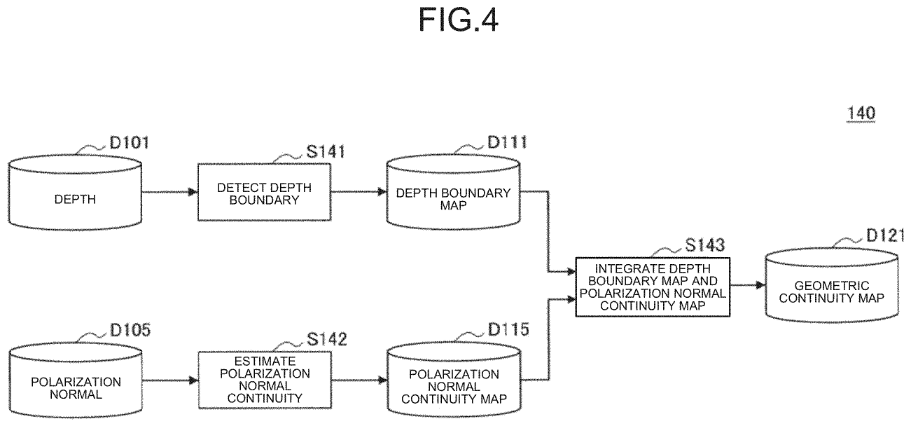

Next, a process of the geometric continuity estimation unit 140 will be described. For example, FIG. 4 is an explanatory diagram illustrating an exemplary flow of the process performed in the geometric continuity estimation unit 140.

As illustrated in FIG. 4, the geometric continuity estimation unit 140 acquires, from the depth estimation unit 120, the information (e.g., the depth map) corresponding to the distance (a depth D101) estimated between the input/output device 20 and the object positioned in the real space. Based on the depth D101 estimated, the geometric continuity estimation unit 140 detects, as a boundary, a region where the depth D101 becomes discontinuous between pixels positioned in a vicinity of each other on the image plane (i.e., the imaging plane). As a more specific example, the geometric continuity estimation unit 140 performs a smoothing process, e.g., using a bilateral filter, on values of the pixels positioned in the vicinity of each other on the image plane (i.e., a value of the depth D101). Subsequently, the geometric continuity estimation unit 140 performs a thresholding process on derivative of the values of the pixels to detect the boundary. As a result of these processes, for example, a boundary between objects at positions, having different depth direction from each other, is detected. Then, the geometric continuity estimation unit 140 generates a depth boundary map D111 where the boundary detected is mapped out on the image plane (S141).

Additionally, the geometric continuity estimation unit 140 acquires, from the normal estimation unit 109, the information (e.g., the normal map) corresponding to a polarization normal D105 estimated. Based on the polarization normal D105 estimated, the geometric continuity estimation unit 140 detects, as a boundary, a region where the polarization normal D105 becomes discontinuous between the pixels positioned in the vicinity of each other on the image plane (i.e., the imaging plane). As a more specific example, the geometric continuity estimation unit 140 detects the boundary based on a difference in the azimuth angle and in the zenith angle, each indicating the polarization normal, between the pixels, based on an angle or an inner product value of a three-dimensional vector, which also indicates the polarization normal, or the like, between the pixels. As a result of the process, the boundary, in which the geometric structure (geometric feature) of the object becomes discontinuous, is detected. The boundary includes, for example, a boundary (edge) between two faces, each of the two faces having a different normal direction from the other. Then, the geometric continuity estimation unit 140 generates a polarization normal continuity map D115 where the boundary detected is mapped out on the image plane (S142).

Next, the geometric continuity estimation unit 140 integrates the depth boundary map D111 and the polarization normal continuity map D115 to generate a geometric continuity map D121 (S143). In this state, for at least some boundary in the geometric continuity map D121, the geometric continuity estimation unit 140 may select the boundary higher in non-continuity between the boundaries illustrated in the depth boundary map D111 and the polarization normal continuity map D115.

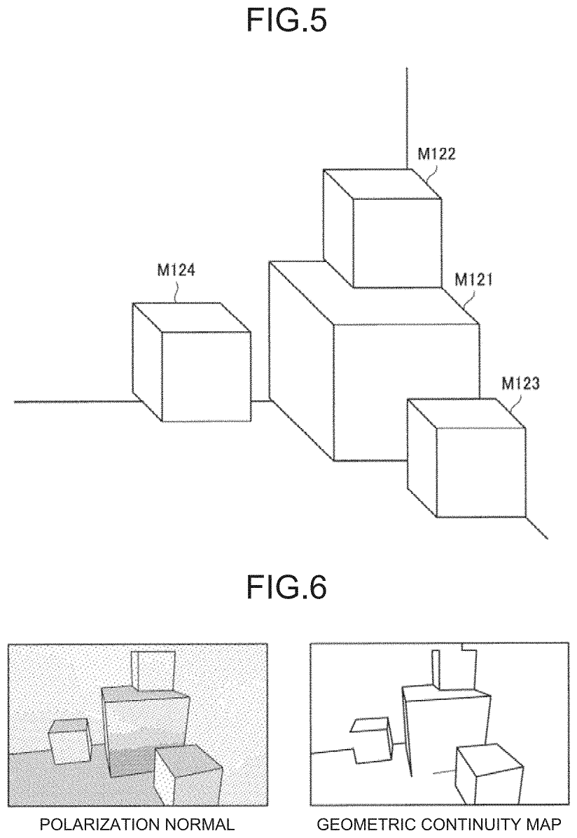

For example, each of FIGS. 5 and 6 is an explanatory diagram illustrating an overview of the geometric continuity map. Specifically, FIG. 5 schematically illustrates three-dimensional space where each of the depth D101 and the polarization normal D105 is to be estimated. For example, in an example illustrated in FIG. 5, real objects M121, M122, M123, and M124 are located, and each of the depth D101 and the polarization normal D105 is estimated on each face of each of the real objects M121 to M124. Further, a left diagram of FIGS. 6 illustrates an example of the information corresponding to the polarization normal D105 estimated (i.e., the normal map) with respect to the three-dimensional space (i.e., the real objects M121 to M124) illustrated in FIG. 5. Concurrently, a right diagram of FIGS. 6 illustrates an example of the geometric continuity map D121 based on the polarization normal D105 estimated as illustrated in the left diagram of FIGS. 6. As may be seen from FIGS. 5 and 6, the geometric continuity map D121 illustrates the boundary where the geometric structure (geometric feature) becomes discontinuous (in other words, the boundary where the geometric continuity no longer exists), such as a boundary between each of the real objects M121 to M124 or a boundary (edge) between two adjacent faces of each of the real objects M121 to M124.

Note that the example of generating the geometric continuity map based on the polarization normal estimated (i.e., the polarization normal continuity map) has been described above; but when it is possible to estimate the geometric continuity, the method is not necessarily limited thereto, i.e., the method based on the polarization normal estimated. As a specific example, the geometric continuity map may be generated based on the polarization information acquired from the polarization image. In other words, when the geometric continuity map is generated based on the distribution of the geometric structure information, the type of information used as the geometric structure information is not particularly limited.

With this configuration, the geometric continuity estimation unit 140 generates the geometric continuity map D121, and outputs the geometric continuity map D121 generated to the integrated processing unit 150 as illustrated in FIG. 3. Note that the geometric continuity estimation unit 140 corresponds to an example of a “second estimation unit”.

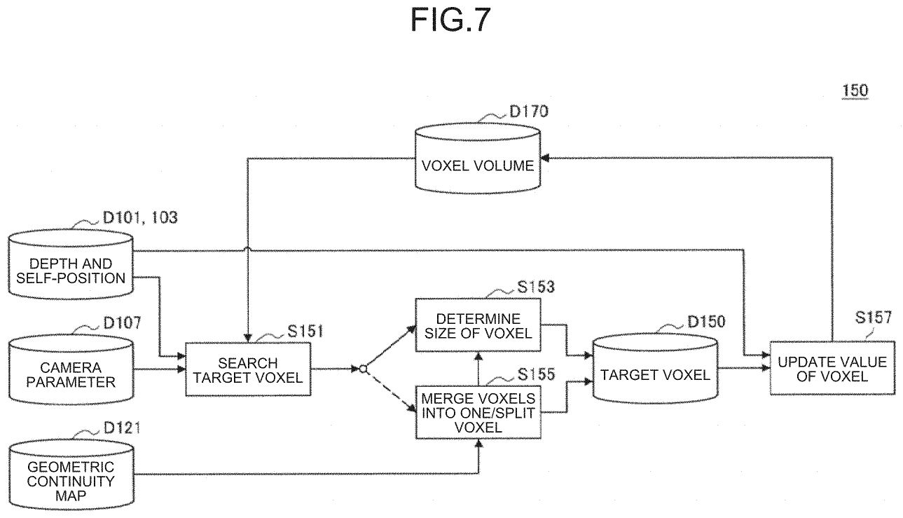

The integrated processing unit 150 uses the depth D101 estimated, a self-position D103 of the input/output device 20, a camera parameter D107, and the geometric continuity map D120 to generate or update a voxel volume D170 where the 3D data is recorded. A process of the integrated processing unit 150 will be described in detail below with reference to FIG. 7. FIG. 7 is an explanatory diagram illustrating an exemplary flow of the process performed in the integrated processing unit 150.

Specifically, the integrated processing unit 150 acquires, from the self-position estimation unit 110, the information corresponding to the self-position D103 of the input/output device 20 estimated. The integrated processing unit 150 acquires, from the depth estimation unit 120, the information corresponding to the distance (depth D101) estimated (e.g., the depth map) between the input/output device 20 and the object positioned in the real space. Additionally, the integrated processing unit 150 acquires, from the input/output device 20, the camera parameter D107 indicating a state of the polarization sensor 230 when capturing the polarization image, based on which the polarization normal D105 is calculated. The camera parameter D107 is, for example, information (frustum) or the like indicating an imaging range within which the polarization sensor 230 captures the polarization image. Further, the integrated processing unit 150 acquires, from the geometric continuity estimation unit 140, the geometric continuity map D121 generated.

The integrated processing unit 150 uses the depth D101 estimated, the self-position D103 of the input/output device 20, and the camera parameter D107, to search a voxel to be updated among the voxel volume D170 where the 3D data is recorded based on the previous estimation results (S151). Hereinafter, data (e.g., the voxel volume) for reconstructing (simulating) the three-dimensional shape of the object in the real space as a model, in other words, the data for reconstructing the real space three-dimensionally will also be referred to as a “three-dimensional space model”.

Specifically, the integrated processing unit 150 projects a representative coordinate of each voxel (for example, a center of the voxel, a top of the voxel, a distance between the center of the voxel and the top of the voxel, or the like) on an imaging plane of the polarization sensor 230, based on the self-position D103 of the input/output device 20 and the camera parameter D107. Then, the integrated processing unit 150 determines whether or not the representative coordinate of each voxel projected is within the image plane (i.e., within the imaging plane of the polarization sensor 230), based on which the integrated processing unit 150 determines whether or not the voxel is positioned within the camera's view cone (frustum) of the polarization sensor 230. The integrated processing unit 150 extracts a group of voxels to be updated in accordance with the determination made as above.

Subsequently, the integrated processing unit 150 inputs the group of voxels extracted to be updated, so as to perform a process to determine a size of each of the voxels (S153) and a process to merge the voxels into one or split the voxel (S155).

In this state, each voxel may not be assigned in the corresponding position when, for example, the algorithm configured to dynamically assign the voxel volume is used. More specifically, when a region that has not previously been observed is observed for the first time, the voxel may not be assigned in the corresponding region. In such a case, in order to newly insert the voxel, the integrated processing unit 150 determines the size of the voxel. The integrated processing unit 150 may determine the size of the voxel based on, for example, the geometric continuity map D121 acquired. Specifically, the integrated processing unit 150 controls to increase the size of the voxel in a region where the geometric continuity is higher (in other words, a region having the simple shape such as a plane). Concurrently, the integrated processing unit 150 controls to reduce the size of the voxel in a region where the geometric continuity is lower (in other words, a region having the complex shape such as an edge).

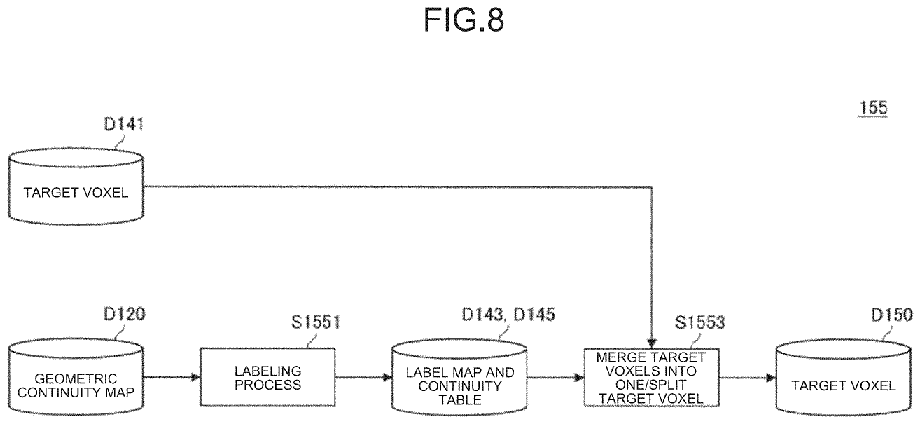

With regard to the voxel already assigned, the integrated processing unit 150 executes a process to merge the voxels into one or split the voxel. For example, FIG. 8 is an explanatory diagram illustrating an exemplary flow of the process to merge the voxels into one or split the voxel.

As illustrated in FIG. 8, the integrated processing unit 150 first performs a labeling process on the geometric continuity map D121 acquired to generate a labeling map D143 and a continuity table D145 (S1551).

Specifically, the integrated processing unit 150 correlates an identical label with a plurality of pixels, positioned in a vicinity of each other and having a gap in value of the geometric continuity below the threshold value, on the image plane of the geometric continuity map D121 acquired, so as to generate the labeling map D143. Further, the integrated processing unit 150 generates the continuity table D145 based on the labeling result. In the continuity table D145, the label that has been correlated with each of the pixels is stored in correspondence to the value of the geometric continuity that has been indicated by the corresponding pixel labeled.

Subsequently, based on the labeling map D143 and the continuity table D145 generated, the integrated processing unit 150 merges the group of voxels extracted to be updated in the process previously described (hereinafter, will also be referred to as a “target voxel D141”) into one, and/or splits the target voxel D141 (S1553).

Specifically, based on the camera parameter D107 and the self-position D103 of the input/output device 20, the integrated processing unit 150 projects a range of each of the target voxels D141 on the imaging plane of the polarization sensor 230. The integrated processing unit 150 collates each of the target voxels D141 projected with the labeling map D143, so as to identify a label for each of the target voxels D141. More specifically, the integrated processing unit 150 correlates a label with the coordinate on the imaging plane of the polarization sensor 230, that is the imaging plane where the representative coordinate of each voxel (e.g., the center of the voxel, the top of the voxel, the distance between the center of the voxel and the top of the voxel, or the like) of the target voxels D141 has been projected. Then, the integrated processing unit 150 identifies the label in correspondence to each of the target voxels D141. When the target voxel D141 projected corresponds to a plurality of labels, the integrated processing unit 150 determines that the target voxel D141 should be adequately smaller than the current size, and correlates the target voxel D141 (smaller than the current size) with a label having lower continuity. In other words, the integrated processing unit 150 splits the target voxel D141 into a plurality of smaller voxels and correlates each of the plurality of smaller voxels with the label having lower continuity.

Then, the integrated processing unit 150 collates the label (that has been correlated with the target voxel D141) with the continuity table D145 so as to extract, from the continuity table D145, the value of the continuity in correspondence to the label. The integrated processing unit 150 calculates the size of the target voxel D141 based on the value of the continuity extracted.

For example, the integrated processing unit 150 merges the group of voxels including the target voxels D141, each in correspondence to the label, into one based on the label, so as to control the size of each of the target voxel D141 included in the group of voxels.

More specifically, the integrated processing unit 150 slides a window indicating a range corresponding to a predetermined size of the voxel (hereinafter will also be referred to as a “search voxel”) within the group of voxels described above. Then, when the search voxel is filled with a plurality of voxels that are correlated with the identical labels, the integrated processing unit 150 sets the plurality of voxels as a single voxel. With this configuration, the integrated processing unit 150 uses the search voxel to search within the group of voxels, and based on a result of the search, integrates (i.e., merges) the plurality of voxels having the size of the search voxel into the single voxel.

When completing the search within the group of voxels by using the search voxel, the integrated processing unit 150 sets the size of the search voxel to be smaller. Then, based on the search voxel set in the smaller size, the integrated processing unit 150 executes the process above again (i.e., using the search voxel set in the smaller size to search within a group of voxels and merging the plurality of voxels having the size of the search voxel into a single voxel). Note that in this state, the integrated processing unit 150 may exclude a range having the single voxel, into which the plurality of voxels have been merged in the previous search, in other words, a range having a voxel larger than the size of the search voxel.

The integrated processing unit 150 sequentially executes the process above, i.e., the process related to searching the voxels and merging the voxels into one, until completing the search based on the search voxel as the minimum size. With this configuration, the integrated processing unit 150 controls to locate the voxel larger in size in the region where the geometric continuity is higher (i.e., the region having the simple shape such as a plane), and to locate the voxel smaller in size in the region where the geometric continuity is lower (i.e., the region having the complex shape, e.g., an edge). In other words, the integrated processing unit 150 determines the size of each of the target voxels included in the groups of voxels based on a distribution of the geometric continuity, and controls the corresponding target voxel based on the size determined. Note that the distribution of the geometric continuity corresponds to an example of a “second distribution”.

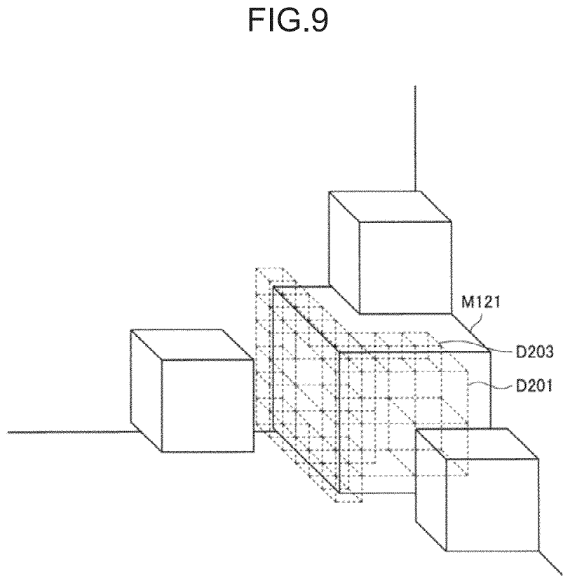

For example, FIG. 9 is an explanatory diagram illustrating an exemplary result of controlling the size of the voxel, and schematically illustrates each of the target voxels when the process related to merging the voxels into and splitting the voxel have completed. The example illustrated in FIG. 9 uses the group of voxels corresponding to the real object M121 illustrated in FIG. 5, and illustrates the exemplary result of controlling the size of the voxel.

In the example illustrated in FIG. 9, a voxel D201 lager in size is assigned in a part having a simpler shape, such as a vicinity of a center in each face of the real object M121. Under this control, with regard to the part having the simpler shape, it is possible to further reduce the volume of the 3D data compared with a case where the voxel smaller in size is assigned in the part. Concurrently, a voxel D203 smaller in size is assigned in a part having a more complex shape, such as a vicinity of edges of the real object M121. Under this control, it is possible to reconstruct the more complex shape at higher accuracy (in other words, the reconstruction is improved).

In the following description, the target voxel that has been controlled in size will also be referred to as a “target voxel D150” so as to be distinguished from the target voxel D141 that is to be controlled in size.

Next, as illustrated in FIG. 7, based on the target voxel D150 that has been controlled in size, the integrated processing unit 150 updates the value of the target voxel D150 included in the voxel volume D170. With this configuration, the size of the voxel included in the voxel volume D170 is updated in accordance with the geometric structure of the real object to be observed (i.e., to be identified), in other words, in accordance with the geometric continuity in each part of the real object. The value of the voxel to be updated corresponds to, for example, the value of the geometric continuity or the like configured to integrate a signed distance function (SDF), weight information, color (texture) information, and geometric continuity information in time direction.

Then, as illustrated in FIG. 3, the integrated processing unit 150 outputs the voxel volume D170 updated (i.e., the three-dimensional space model) and the data in correspondence to the voxel volume D170 updated (i.e., the data for reconstructing (simulating) the three-dimensional shape of the object in the real space as a model) as output data to a predetermined output destination.

Note that the information processing device 10 may update the three-dimensional space model (e.g., the voxel volume) regarding the position and/or the orientation of each of the viewpoints (e.g., input/output device 20) based on the depth information and/or the polarization information acquired from the position and/or the orientation of the corresponding viewpoint, instead of performing a series of process steps described above. Particularly, when the three-dimensional space model is updated in accordance with the geometric continuity estimated based on the information acquired from the plurality of viewpoints, the three-dimensional shape of the object in the real space may be reconstructed at higher accuracy than in a case based on information acquired from a single viewpoint. Additionally, when the position and/or the orientation of each of the viewpoints sequentially changes in a chronological order, the information processing device 10 may incorporate the geometric continuity, which is estimated sequentially in accordance with the change in the position and/or the orientation of the corresponding viewpoint, in the time direction, so as to update the three-dimensional space model. Under this control, it is possible to reconstruct the three-dimensional shape of the object in the real space at higher accuracy.

Note that, in the examples described above, the voxel included in the voxel volume corresponds to an example of “unit data” configured to simulate the three-dimensional space, in other words, the “unit data” configured to generate the three-dimensional space model. When it is possible to simulate the three-dimensional space, the data for simulating the three-dimensional space is not limited to the voxel volume; and the unit data included in the data for simulating the three-dimensional space is not limited to a voxel. For example, a 3D polygon mesh may be used for the three-dimensional space model. In this case, predetermined partial data for the 3D polygon mesh (for example, one face having at least three sides) may be used as the unit data.

Note that the functional configuration of the information processing system 1 according to this embodiment described above is merely illustrative. Thus, when each of the structural elements of the information processing system 1 is capable of performing the corresponding process above, the functional configuration is not necessarily limited to the example illustrated in FIG. 3. As a specific example, the input/output device 20 and the information processing device 10 may be integrally formed. As another example, some of the structural elements of the information processing device 10 may be provided in other devices than the information processing device 10 (e.g., the input/output device 20, a server, or the like). Further, a plurality of devices may be operated in cooperation with each other to serve each function of the information processing device 10.

The functional configuration example of the information processing system according to this embodiment has been described above with reference to FIGS. 3 to 8.

<3.2. Process>

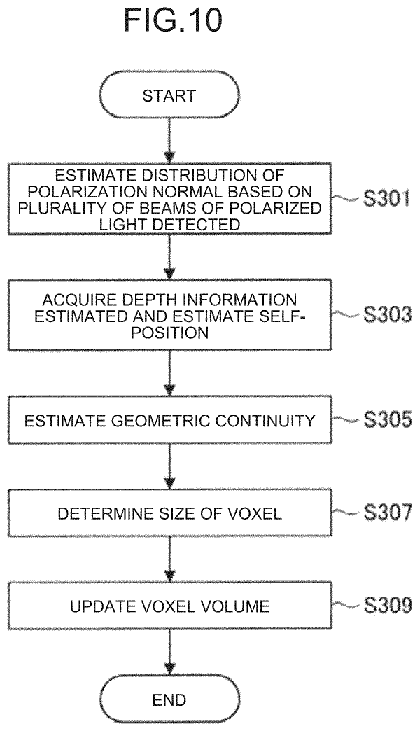

Next, an exemplary flow of a series of process steps of the information processing system according to this embodiment, particularly focused on the process performed in the information processing device 10, will be described. For example, FIG. 10 is a flowchart illustrating the exemplary flow of the series of process steps performed in the information processing system according to this embodiment.

The information processing device 10 (normal estimation unit 109) acquires the polarization image from the polarization sensor 230. Based on the polarization information included in the polarization image acquired, the information processing device 10 estimates the distribution of the polarization normal of at least part of the face of the object in the real space captured in the polarization image (S301).

The information processing device 10 (self-position estimation unit 110) estimates the position of the input/output device 20 (particularly, the polarization sensor 230) in the real space. As a specific example, the information processing device 10 may estimate the self-position of the input/output device 20 based on the technique called SLAM. In this case, the information processing device 10 may estimate the self-position of the input/output device 20 based on the depth information acquired by the depth sensor 201 and the relative change in position and/or orientation of the input/output device 20 detected by the predetermined sensor (e.g., the acceleration sensor, the angular velocity sensor, or the like) (S303).

Based on the distribution of the polarization normal estimated, the information processing device 10 (geometric continuity estimation unit 140) detects the boundary where the geometric structure of the object becomes discontinuous (e.g., the boundary where the distribution of the polarization normal becomes discontinuous), such as the boundary (edge) between two faces, each having a different normal direction from the other, so as to estimate the geometric continuity. Then, based on the continuity of the geometric structure (geometric continuity) estimated, the information processing device 10 generates the geometric continuity map (S305). The process to generate the geometric continuity map has been described, and thus a detailed description thereof will be omitted.

The information processing device 10 (integrated processing unit 150) uses the distance (depth) estimated between the input/output device 20 and the object positioned in the real space, the self-position of the input/output device 20, and the camera parameter indicating the state of the polarization sensor 230 in order to search and extract the voxel to be updated. The information processing device 10 determines the size of the voxel extracted to be updated (i.e., the target voxel) based on the geometric continuity map generated. As a specific example, the information processing device 10 controls to increase the size of the voxel in the region where the geometric continuity is higher, and to reduce the size of the voxel in the region where the geometric continuity is lower. In this state, with regard to the voxel already assigned, the information processing device 100 may merge the plurality of voxels into one in larger size and/or split the single voxel into a plurality of voxels in smaller size based on the size of the voxel determined (S307).

The information processing device 10 (integrated processing unit 150) uses the voxel in the size controlled in order to update the value of the voxel to be updated among the voxel volume where the 3D data is recorded based on the previous estimation results. As a result, the voxel volume is updated (S309).

Then, the voxel volume (i.e., the three-dimensional space model) updated or the data in correspondence to the voxel volume is output as the output data to the predetermined output destination.

The exemplary flow of the series of process steps of the information processing system according to this embodiment, particularly focused on the process performed in the information processing device 10, has been described above with reference to FIG. 10.

«4. Hardware Configuration»

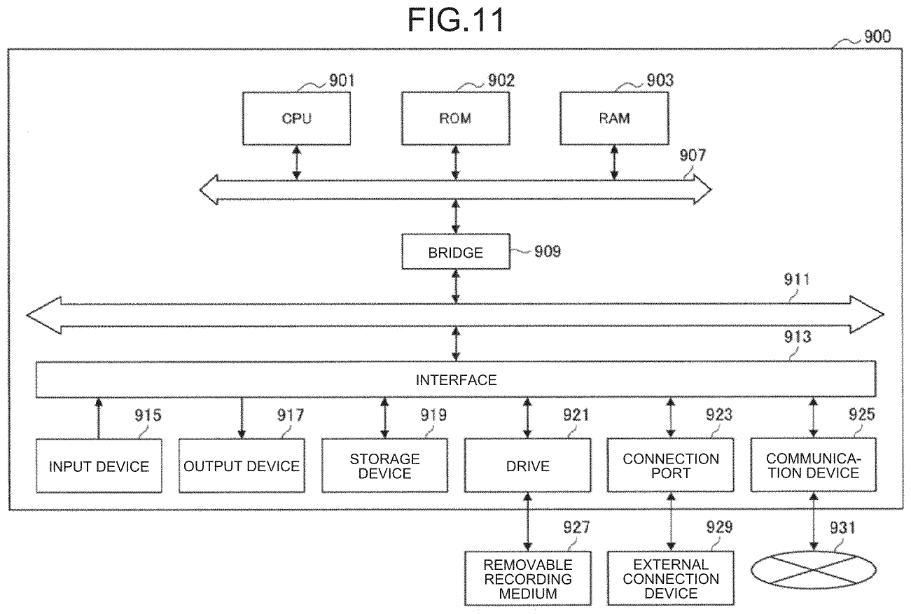

Next, as has been described with regard to the information processing device 10, an example of a hardware configuration of an information processing device included in the information processing system according to an embodiment of the present disclosure will be described in detail with reference to FIG. 11. FIG. 11 is a functional block diagram illustrating the hardware configuration example of the information processing device included in the information processing system according to the embodiment of the present disclosure.

An information processing device 900 included in the information processing system according to this embodiment mainly includes a CPU 901, an ROM 902, and an RAM 903. The information processing device 900 further includes a host bus 907, a bridge 909, an external bus 911, an interface 913, an input device 915, an output device 917, a storage device 919, a drive 921, a connection port 923, and a communication device 925.

The CPU 901 serves as an arithmetic processing device and a control device, and controls an overall operation or a part of the operation of the information processing device 900 in accordance with various programs recorded in the ROM 902, the

RAM 903, the storage device 919, or a removable recording medium 927. The ROM 902 stores programs, operation parameters, or the like, each used in the CPU 901. The RAM 903 temporarily stores the programs used in the CPU 901, parameters that change as appropriate in execution of the programs, and the like. The CPU 901, the ROM 902, and the RAM 903 are connected with each other via the host bus 907 that is configured from an internal bus such as a CPU bus. For example, the self-position estimation unit 110, the depth estimation unit 120, the normal estimation unit 130, the geometric continuity estimation unit 140, and the integrated processing unit 150, each illustrated in FIG. 3, may include the CPU 901.

The host bus 907 is connected to the external bus 911, e.g., a peripheral component interconnect/interface (PCI) bus, via the bridge 909. The external bus 911 is also connected to the input device 915, the output device 917, the storage device 919, the drive 921, the connection port 923, and the communication device 925 via the interface 913.

The input device 915 is, for example, an operation means operated by the user, such as a mouse, a keyboard, a touch panel, a button, a switch, a lever, or a pedal. The input device 915 may be a remote control means (a typically-called remote control) that uses, for example, infrared radiation or other radio waves. Alternatively, the input device 915 may be an external connection device 929, such as a mobile phone or a PDA, each corresponding to the operation of the information processing device 900. The input device 915 includes, for example, an input control circuit or the like that generates an input signal based on information input by the user using the operation means above and outputs the input signal to the CPU 901. The user of the information processing device 900 may operate the input device 915 to input various types of data and command processing operations to the information processing device 900.

The output device 917 is a device capable of visually or audibly reporting information acquired to the user. The output device 917 may be, for example, a display device such as a CRT display, a liquid crystal display, a plasma display, an EL display, or a lamp; a sound output device such as a speaker or a headphone; or a printer. The output device 917 outputs a result obtained through various processes performed in the information processing device 900. Specifically, the display device displays the result obtained through the various processes performed in the information processing device 900 as a text or an image. On the other hand, the sound output device converts an audio signal composed of reproduced sound data, acoustic data, or the like, into an analog signal, and outputs the analog signal.

The storage device 919 is a data storage device as an example of a storage unit of the information processing device 900. The storage device 919 is, for example, a magnetic storage device such as a hard disk drive (HDD), a semiconductor storage device, an optical storage device, a magneto-optical storage device, or the like. The storage device 919 stores therein various data, programs, or the like that the CPU 901 is to execute.

The drive 921 is a reader/writer for a recording medium, and is built in or externally attached to the information processing device 900. The drive 921 reads out information recorded on the removable recording medium 927 mounted, such as a magnetic disk, an optical disk, a magnetic optical disk or a semiconductor memory, and outputs the information to the RAM 903. The drive 921 may write the record into the removable recording medium 927 mounted, such as the magnetic disk, the optical disk, the magnetic optical disk, or the semiconductor memory. The removable recording medium 927 is, for example, a DVD medium, an HD-DVD medium, a Blu-ray (registered trademark) medium, or the like. Alternatively, the removable recording medium 927 may be a compact flash (CF: registered trademark) card, a flash memory card, a secure digital (SD) memory card, or the like. Still alternatively, the removable recording medium 927 may be, for example, an integrated circuit (IC) card with a non-contact IC chip mounted, an electronic device, or the like.

The connection port 923 is a port used to directly connect equipment to the information processing device 900. The connection port 923 may be, as an example, a universal serial bus (USB) port, an IEEE1394 port, a small computer system interface (SCSI), or the like. The connection port 923 may be, as another example, an RS-232C port, an optical audio terminal, a high-definition multimedia interface (HDMI) port (registered trademark), or the like. The connection port 923 is connected to the external connection device 929. This configuration enables the information processing device 900 to acquire various data directly from the external connection device 929 or provide the various data to the external connection device 929.

The communication device 925 is a communication interface including, for example, a communication device or the like used for connection to a communication network (network) 931. The communication device 925 is, for example, a wired or wireless local area network (LAN), Bluetooth (registered trademark), a communication card for a wireless USB (WUSB), or the like. Alternatively, the communication device 925 may be, for example, a router for optical communication, a router for asymmetric digital subscriber line (ADSL), a modem for various types of communication, or the like. For example, the communication device 925 transmits/receives a signal or the like on the Internet or to/from another communication device by using a predetermined protocol such as TCP/IP, for example. The communication network 931 connected to the communication device 925 is a network established through wired or wireless connection, and may be, for example, the Internet, a home LAN, infrared communication, radio communication, or satellite communication.

The example of the hardware configuration, which is capable of serving the function of the information processing device 900 included in the information processing system according to the embodiment of the present disclosure, has been described above. Each of the structural elements described above may be a general-purpose member, or may be hardware specialized in the function of the corresponding structural element. Thus, it is possible to change the hardware configuration used as appropriate, in accordance with the technical level at the time of implementing this embodiment. It is naturally to be understood that the hardware configuration, while not illustrated in FIG. 11, includes various structural elements corresponding to those of the information processing device 900 included in the information processing system.

Note that it is possible to create a computer program configured to serve each of the functions of the information processing device 900 in the information processing system according to this embodiment, and possible to install the computer program to a personal computer or the like. It is also possible to provide a computer readable recording medium storing such a computer program. The recording medium is, for example, the magnetic disk, the optical disk, the magneto-optical disk, the flash memory card, or the like. The computer program above may also be distributed via, for example, the network, instead of the recording medium. The number of the computers configured to execute the computer program is not particularly limited. For example, a plurality of computers (e.g., a plurality of servers or the like) may be operated in cooperation with each other to execute the computer program.

«5. Conclusion»

As has been described above, the information processing device according to this embodiment estimates, based on each of the plurality of beams of polarized light, having different polarization directions from each other, detected by the polarization sensor, the distribution of the geometric structure information (e.g., polarization normal) regarding at least part of the face of the object in the real space as the first distribution. The information processing device also estimates, based on the first distribution estimated as above, the distribution of information related to the continuity of the geometric structure in the real space as the second distribution. An example of the second distribution includes the geometric continuity map described above. Then, the information processing device determines the size of the unit data (e.g., the voxel) configured to simulate the three-dimensional space, in accordance with the second distribution. As a specific example, the information processing device controls to increase the size of the unit data in the part where the continuity of the geometric structure is high (e.g., the region having the simple shape such as a plane). Concurrently, the information processing device controls to reduce the size of the unit data in the part where the continuity of the geometric structure is low (e.g., the region having the complex shape such as an edge).

Under the control described above, for example, the voxel larger in size is located in the region where the continuity of the geometric structure is high, and the voxel smaller in size is located in the region where the geometric continuity is low. Accordingly, with regard to the part having the simple shape such as a plane, it is possible to further reduce the volume of the 3D data compared with the case in which the voxel smaller in size is assigned in the same part. Concurrently, with regard to the part having the complex shape such as an edge, the voxel smaller in size is located, and the shape is thereby accurately reconstructed (in other words, the reconstruction is improved). In other words, with the information processing system according to this embodiment, it is possible to reduce the volume of the data for the model reconstructed from the object in the real space (e.g., the three-dimensional space model such as the voxel volume) and to reconstruct the shape of the object as a further preferable aspect.

The preferred embodiment of the present disclosure has been described above in detail with reference to the accompanying drawings, whilst the present disclosure is not limited to the above examples. A person skilled in the art may find various alterations and modifications within the scope of the appended claims, and it should be understood that they will naturally come under the technical scope of the present disclosure.

Note that, in the examples described above, the technique according the present disclosure has been mainly described in its application to the AR technique or the VR technique; however, the application of the technique according the present disclosure is not necessarily limited thereto. In other words, the technique according to the present disclosure may be applied to another technique using the data for reconstructing a three-dimensional shape of an object in real space as a model, e.g., the voxel volume (in other words, using a three-dimensional space model). As a specific example, a polarization sensor or a depth sensor may be provided to a mobile object, such as a vehicle or a drone, to generate the three-dimensional space model, simulating an environment surrounding the mobile object, based on information acquired by the polarization sensor or the depth sensor.

Note also that the example, in which an eyeglasses wearable device is applied as the input/output device 20, has been described above; however, when it is possible to fulfill the function for the system according to the present disclosure as described above, the configuration of the input/output device 20 is not limited thereto. As a specific example, a terminal device configured to be portable, such as a smartphone, may be applied as the input/output device 20. Further, a configuration of a device to be applied as the input/output device 20 may be appropriately changed in accordance with the application of the technique according the present disclosure.

Further, the effects described in this specification are merely illustrative or exemplified effects, and are not limitative. That is, in addition to or in place of the effects described above, the technology according to the present disclosure may achieve other effects that are clear to those skilled in the art from the description of this specification.

Additionally, the technology of the present disclosure may also be configured as below.

(1)

An information processing device comprising:
a first estimation unit configured to estimate a first distribution of geometric structure information regarding at least a part of a face of an object in real space, in accordance with each of a plurality of beams of polarized light, having different polarization directions from each other, as a result detected by a polarization sensor;
a second estimation unit configured to estimate a second distribution of information related to continuity of a geometric structure in the real space based on an estimation result of the first distribution; and
a processing unit configured to determine a size of unit data for simulating three-dimensional space in accordance with the second distribution.

(2)

The information processing device according to (1), wherein the processing unit determines the size of the unit data in the second distribution to locate the unit data, having a larger size than the unit data in a part where the continuity of the geometric structure is low, in a part where the continuity of the geometric structure is high.

(3)

The information processing device according to (2), wherein the processing unit determines the size of the unit data in the second distribution to include at least a partial region, in which a change amount of the information is included within a predetermined range, into one of the unit data, the information related to the continuity of the geometric structure having faces adjacent to each other.

(4)

The information processing device according to (3), wherein the processing unit determines the size of the unit data by changing the size of the unit data sequentially, while searching at least the partial region that is included in the unit data having the size changed sequentially.

(5)

The information processing device according to any one of (1) to (4), wherein
the first estimation unit estimates the first distribution from each of a plurality of viewpoints that are different from each other, in accordance with each of the plurality of beams of polarized light as a result detected from each of the plurality of viewpoints, and
the second estimation unit estimates a distribution of the information related to the continuity of the geometric structure in accordance with the first distribution estimated from each of the plurality of viewpoints.

(6)

The information processing device according to (5), wherein
each of the plurality of viewpoints is configured to be movable, and
the first estimation unit estimates the first distribution from each of the plurality of viewpoints at each of a plurality of different timing points in a chronological order, in accordance with each of the plurality of beams of polarized light as a result detected from each of the plurality of viewpoints at each of the plurality of different timing points.

(7)

The information processing device according to any one of (1) to (6), further comprising an acquisition unit configured to acquire an estimation result of a distance between a predetermined viewpoint and the object, wherein
the second estimation unit estimates a distribution related to the continuity of the geometric structure based on the estimation result of the first distribution and the estimation result of the distance between the predetermined viewpoint and the object.

(8)

The information processing device according to (7), wherein the second estimation unit estimates a boundary between objects that are different from each other in the first distribution, in accordance with the estimation result of the distance, and based on an estimation result of the border, the second estimation unit estimates the distribution related to the continuity of the geometric structure.

(9)

The information processing device according to (7) or (8), wherein the acquisition unit acquires a depth map where the estimation result of the distance is mapped out on an image plane.

(10)

The information processing device according to any one of (1) to (7), wherein the unit data corresponds to a voxel.

(11)

The information processing device according to any one of (1) to (10), wherein the geometric structure information corresponds to information related to a normal of the face of the object.

(12)

The information processing device according to (11), wherein the information related to the normal corresponds to information indicating the normal of the face of the object as a form of an azimuth angle and a zenith angle.

(13)

The information processing device according to (12), wherein the information related to the continuity of the geometric structure corresponds to information that is in accordance with a difference in at least one of the azimuth angle and the zenith angle between a plurality of coordinates positioned in a vicinity of each other in the first distribution.

(14)

The information processing device according to (11), wherein the information related to the normal corresponds to information indicating the normal of the face of the object as a form of a three-dimensional vector.

(15)

The information processing device according to (14), wherein the information related to the continuity of the geometric structure corresponds to information that is in accordance with at least one of an angle of the three-dimensional vector and an inner product value of the three-dimensional vector between the plurality of coordinates positioned in the vicinity of each other in the first distribution.

(16)

An information processing method performed by a computer, the information processing method comprising:
estimating a first distribution of geometric structure information regarding at least a part of a face of an object in real space, in accordance with each of a plurality of beams of polarized light, having different polarization directions from each other, as a result detected by a polarization sensor;
estimating a second distribution of information related to continuity of a geometric structure in the real space based on an estimation result of the first distribution; and
determining a size of unit data for simulating three-dimensional space in accordance with the second distribution.

(17)

A recording medium recording a program for causing a computer to execute:
estimating a first distribution of geometric structure information regarding at least a part of a face of an object in real space, in accordance with each of a plurality of beams of polarized light, having different polarization directions from each other, as a result detected by a polarization sensor;
estimating a second distribution of information related to continuity of a geometric structure in the real space based on an estimation result of the first distribution; and
determining a size of unit data for simulating three-dimensional space in accordance with the second distribution.

### REFERENCE SIGNS LIST

1 INFORMATION PROCESSING SYSTEM

10 INFORMATION PROCESSING DEVICE

100 INFORMATION PROCESSING DEVICE

109 NORMAL ESTIMATION UNIT

110 SELF-POSITION ESTIMATION UNIT

120 DEPTH ESTIMATION UNIT

130 NORMAL ESTIMATION UNIT

140 GEOMETRIC CONTINUITY ESTIMATION UNIT

150 INTEGRATED PROCESSING UNIT

20 INPUT/OUTPUT DEVICE

201 DEPTH SENSOR

230 POLARIZATION SENSOR

1. An information processing device comprising:
a first estimation unit configured to estimate a first distribution of geometric structure information regarding at least a part of a face of an object in real space, in accordance with each of a plurality of beams of polarized light, having different polarization directions from each other, as a result detected by a polarization sensor;
a second estimation unit configured to estimate a second distribution of information related to continuity of a geometric structure in the real space based on an estimation result of the first distribution; and
a processing unit configured to determine a size of unit data for simulating three-dimensional space in accordance with the second distribution.

2. The information processing device according to claim 1, wherein the processing unit determines the size of the unit data in the second distribution to locate the unit data, having a larger size than the unit data in a part where the continuity of the geometric structure is low, in a part where the continuity of the geometric structure is high.

3. The information processing device according to claim 2, wherein the processing unit determines the size of the unit data in the second distribution to include at least a partial region, in which a change amount of the information is included within a predetermined range, into one of the unit data, the information related to the continuity of the geometric structure having faces adjacent to each other.

4. The information processing device according to claim 3, wherein the processing unit determines the size of the unit data by changing the size of the unit data sequentially, while searching at least the partial region that is included in the unit data having the size changed sequentially.

5. The information processing device according to claim 1, wherein
the first estimation unit estimates the first distribution from each of a plurality of viewpoints that are different from each other, in accordance with each of the plurality of beams of polarized light as a result detected from each of the plurality of viewpoints, and
the second estimation unit estimates a distribution of the information related to the continuity of the geometric structure in accordance with the first distribution estimated from each of the plurality of viewpoints.

6. The information processing device according to claim 5, wherein
each of the plurality of viewpoints is configured to be movable, and
the first estimation unit estimates the first distribution from each of the plurality of viewpoints at each of a plurality of different timing points in a chronological order, in accordance with each of the plurality of beams of polarized light as a result detected from each of the plurality of viewpoints at each of the plurality of different timing points.

7. The information processing device according to claim 1, further comprising an acquisition unit configured to acquire an estimation result of a distance between a predetermined viewpoint and the object, wherein
the second estimation unit estimates a distribution related to the continuity of the geometric structure based on the estimation result of the first distribution and the estimation result of the distance between the predetermined viewpoint and the object.

8. The information processing device according to claim 7, wherein the second estimation unit estimates a boundary between objects that are different from each other in the first distribution, in accordance with the estimation result of the distance, and based on an estimation result of the border, the second estimation unit estimates the distribution related to the continuity of the geometric structure.

9. The information processing device according to claim 7, wherein the acquisition unit acquires a depth map where the estimation result of the distance is mapped out on an image plane.

10. The information processing device according to claim 1, wherein the unit data corresponds to a voxel.

11. The information processing device according to claim 1, wherein the geometric structure information corresponds to information related to a normal of the face of the object.

12. The information processing device according to claim 11, wherein the information related to the normal corresponds to information indicating the normal of the face of the object as a form of an azimuth angle and a zenith angle.

13. The information processing device according to claim 12, wherein the information related to the continuity of the geometric structure corresponds to information that is in accordance with a difference in at least one of the azimuth angle and the zenith angle between a plurality of coordinates positioned in a vicinity of each other in the first distribution.

14. The information processing device according to claim 11, wherein the information related to the normal corresponds to information indicating the normal of the face of the object as a form of a three-dimensional vector.

15. The information processing device according to claim 14, wherein the information related to the continuity of the geometric structure corresponds to information that is in accordance with at least one of an angle of the three-dimensional vector and an inner product value of the three-dimensional vector between the plurality of coordinates positioned in the vicinity of each other in the first distribution.

16. An information processing method performed by a computer, the information processing method comprising:
estimating a first distribution of geometric structure information regarding at least a part of a face of an object in real space, in accordance with each of a plurality of beams of polarized light, having different polarization directions from each other, as a result detected by a polarization sensor;
estimating a second distribution of information related to continuity of a geometric structure in the real space based on an estimation result of the first distribution; and
determining a size of unit data for simulating three-dimensional space in accordance with the second distribution.

17. A recording medium recording a program for causing a computer to execute:
estimating a first distribution of geometric structure information regarding at least a part of a face of an object in real space, in accordance with each of a plurality of beams of polarized light, having different polarization directions from each other, as a result detected by a polarization sensor;
estimating a second distribution of information related to continuity of a geometric structure in the real space based on an estimation result of the first distribution; and
determining a size of unit data for simulating three-dimensional space in accordance with the second distribution.
